(19) United States
(12) Patent Application Publication
(10) Pub. No.: US 2018/0204186 A1
(43) Pub. Date: Jul. 19, 2018

(54) METHOD FOR SHARING SCHEDULE AND ELECTRONIC DEVICE IMPLEMENTING THE SAME

(71) Applicant: SAMSUNG ELECTRONICS CO., LTD., Suwon-si (KR)

(72) Inventor: Taewon KWAK, Seoul (KR)

(21) Appl. No.: 15/869,842

(22) Filed: Jan. 12, 2018

(30) Foreign Application Priority Data
Jan. 19, 2017 (KR) 10-2017-0009249

(51) Int. Cl. G06Q 10/10; H04W 4/02; H04W 4/08; H04W 4/12; H04W 4/44; G06F 3/0482

(52) U.S. Cl. CPC G06Q 10/1093; H04W 4/02; G06F 3/0482; H04W 4/12; H04W 4/44; H04W 4/08

(57) ABSTRACT

An electronic device is provided, which includes a display including a touch screen; a communication unit configured to communicate with a server, an external electronic device, and a second external electronic device; a sensor unit; a processor; and a memory electrically connected to the processor, wherein the memory, when executed, stores instructions to cause the processor to set schedule information, to generate a group to share the schedule information, to control the communication unit to request external electronic devices related to the generated group to approve group generation, to control the display to display a user interface including the schedule information and user information of the external electronic devices that have approved the group generation, to control the communication unit to receive event information from the external electronic devices, and to control the display to display the received event information.

### CROSS-REFERENCE TO RELATED APPLICATION(S)

This application is based on and claims priority under 35 U.S.C. § 119 to Korean Patent Application No. 10-2017-0009249, filed on Jan. 19, 2017 in the Korean Intellectual Property Office, the entire disclosure of which is incorporated herein by reference.

### BACKGROUND

### Field

The disclosure relates to a method for sharing a schedule and/or an electronic device implementing the same.

### Description of the Related Art

In recent years, as an electronic device has an information processing function, personal or business schedule management using an electronic device has been widely used. Further, users may receive notifications on schedules registered by the users themselves using notification functions implemented on the electronic device.

### SUMMARY

A schedule notification method up to now can provide a passive function in which if a user sets an alert on user's schedule, the alert is provided to the corresponding user in accordance with the set contents.

Further, if a communication is required between several users who share a schedule, the users should make contact with each other through other means separately from a schedule related application to cause the limitations.

Various example embodiments of the disclosure are to set users who intend to share a schedule into groups, and to provide various events between the groups.

According to various example embodiments of the disclosure, an electronic device includes a display including a touch screen; a communication unit configured to communicate with a server, an external electronic device, and a second external electronic device; a sensor unit; a processor; and a memory electrically connected to the processor, wherein the memory, when executed, stores instructions to cause the processor to set schedule information, to generate a group to share the schedule information, to control the communication unit to request external electronic devices related to the generated group to approve group generation, to control the display to display a user interface including the schedule information and user information of the external electronic devices that have approved the group generation, to control the communication unit to receive event information from the external electronic devices, and to control the display to display the received event information.

According to the various example embodiments of the disclosure, the method for sharing the schedule and the electronic device implementing the same can set the users who intend to share the schedule to groups, and can confirm an alert recognition state of other users through exchanging various events between the groups.

According to the various example embodiments of the disclosure, the method for sharing the schedule and the electronic device implementing the same can provide communication (e.g., message transmission or voice message transmission) between the groups on a schedule related application as one event being exchanged.

### BRIEF DESCRIPTION OF THE DRAWINGS

FIG. 1 is a block diagram illustrating an electronic device in a network environment according to various example embodiments of the present disclosure;

FIG. 2 is a block diagram of an electronic device according to various example embodiments of the present disclosure;

FIG. 3 is a block diagram of a program module according to various example embodiments of the present disclosure;

FIG. 4 is a diagram illustrating the configuration of a system according to various example embodiments of the present disclosure;

FIG. 5 is a flowchart illustrating a schedule sharing operation according to various example embodiments of the present disclosure;

FIG. 6 is a sequence diagram illustrating a schedule sharing operation according to various example embodiments of the present disclosure;

FIG. 7 is a sequence diagram illustrating a schedule sharing operation according to various example embodiments of the present disclosure;

FIG. 8 is an exemplary diagram for setting schedule information according to various example embodiments of the present disclosure;

FIGS. 9A, 9B, and 10 are exemplary diagrams for designating a group according to various example embodiments of the present disclosure;

FIGS. 11A, 11B, and 11C are diagrams illustrating a user interface according to various example embodiments of the present disclosure;

FIGS. 12A and 12B are exemplary diagrams for sharing information with a second external electronic device according to various example embodiments of the present disclosure; and

FIGS. 13A and 13B are diagrams illustrating a user interface according to various example embodiments of the present disclosure.

### DETAILED DESCRIPTION OF EXAMPLE EMBODIMENTS

The following description with reference to the accompanying drawings, in which like reference numerals may indicate like parts throughout the several views, is provided to assist in a comprehensive understanding of various example embodiments of the present disclosure as defined by the claims and their equivalents. It includes various specific details to assist in that understanding but these are to be regarded as merely exemplary. Accordingly, those of ordinary skill in the art will recognize that various changes and modifications of the various example embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly indicates otherwise. Thus, for example, reference to “a component surface” includes reference to one or more of such surfaces.

In this disclosure, the expression “A or B” or “at least one of A and/or B” may include A, may include B, or may include both A and B. Expressions including ordinal numbers, such as “first” and “second,” etc., may modify various elements. However, the above expressions do not limit the sequence and/or importance of the elements and are used merely for the purpose to distinguish an element from the other elements. In case where a certain (e.g., the first) element is referred to as being “connected” or “accessed” (functionally or communicatively) to other (e.g., the second) element, it should be understood that the element is connected or accessed directly to the other element or through another (e.g., the third) element. In this disclosure, the expression “configured to” may be used, depending on situations, interchangeably with “adapted to”, “having the ability to”, “modified to”, “made to”, “capable of”, or “designed to”. In some situations, the expression “device configured to” may mean that the device may operate with other device(s) or other component(s). For example, the expression “processor configured to perform A, B and C” may mean a dedicated processor (e.g., an embedded processor) for performing the above operations, or a general-purpose processor (e.g., central processing unit (CPU) or an application processor (AP)) capable of performing the above operations by executing one or more software programs stored in a memory device. An electronic device according to various example embodiments of this disclosure may include at least one of a smart phone, a tablet personal computer (PC), a mobile phone, a video phone, an e-book reader, a desktop PC, a laptop PC, a netbook computer, a workstation, a server, a personal digital assistant (PDA), a portable multimedia player (PMP), a Moving Picture Experts Group phase 1 or phase 2 (MPEG-1 or MPEG-2) audio layer 3 (MP3) player, a medical device, a camera, and a wearable device. For example, a wearable device may include at least one of an accessory type (e.g., a watch, a ring, a bracelet, an anklet, a necklace, an electronic accessory, eyeglasses, contact lenses, or a head-mounted device (HMD)), a textile or cloth assembled type (e.g., electronic clothing), a body attached type (e.g., a skin pad or tattoo), and a body transplant circuit. In some example embodiments, an electronic device may include at least one of a television (TV), a digital versatile disc (DVD) player, an audio device, a refrigerator, an air-conditioner, a vacuum cleaner, an oven, a microwave, a washing machine, an air cleaner, a set-top box, a home automation control panel, a security control panel, a media box (e.g., Samsung HomeSync™, Apple TV™, or Google TV™), a game console (e.g., Xbox™, PlayStation™), an electronic dictionary, an electronic key, a camcorder, and an electronic frame.

In various example embodiments of the present disclosure, an electronic device may include at least one of various medical devices (e.g., magnetic resonance angiography (MRA), magnetic resonance imaging (MRI), computed tomography (CT), a scanning machine, an ultrasonic wave device, etc.), a navigation device, a global navigation satellite system (GNSS), an event data recorder (EDR), a flight data recorder (FDR), a vehicle infotainment device, an electronic equipment for a ship (e.g., navigation equipment for a ship, gyrocompass, etc.), avionics, a security device, a head unit or device for a vehicle, an industrial or home robot, a drone, an automated teller machine (ATM), a point of sales (POS), and various Internet of things (IoT) devices (e.g., a lamp, various sensors, a sprinkler, a fire alarm, a thermostat, a street light, a toaster, athletic equipment, a hot water tank, a heater, a boiler, etc.). According to a certain example embodiment, an electronic device may include at least one of furniture, a portion of a building/structure or car, an electronic board, an electronic signature receiving device, a projector, and various measuring meters (e.g., a water meter, an electric meter, a gas meter, a wave meter, etc.). In various example embodiments, an electronic device may be flexible or a combination of two or more of the aforementioned devices. An electronic device according to various example embodiments of this disclosure is not limited to the aforementioned devices. In this disclosure, the term a user may refer to a person who uses an electronic device, or a machine (e.g., an artificial intelligence device) which uses an electronic device.

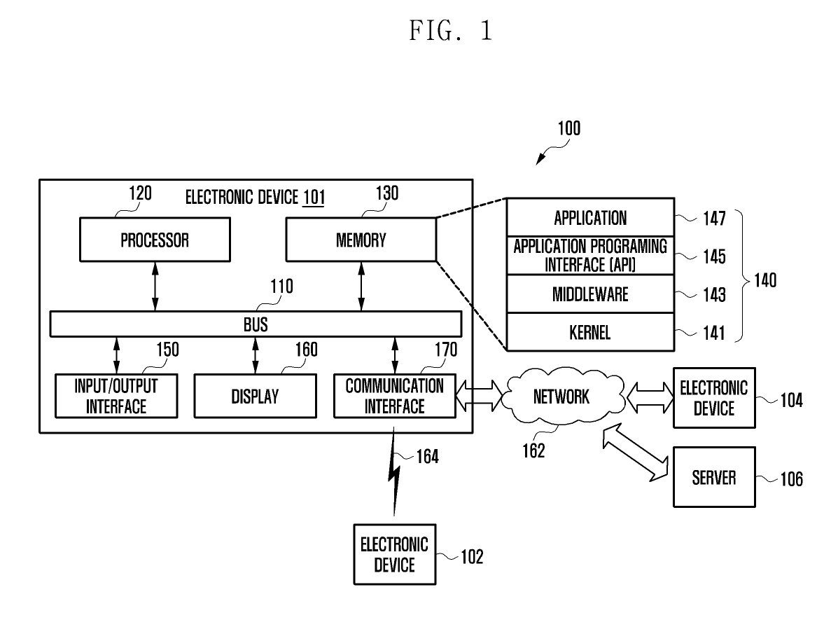

FIG. 1 is a block diagram illustrating a network environment 100 including therein an electronic device 101 in accordance with various example embodiments of the present disclosure.

Referring to FIG. 1, the electronic device 101 may include, but is not limited to, a bus 110, a processor 120 (including processing circuitry), a memory 130, an input/output interface 150 (including interface circuitry), a display 160, and a communication interface 170 (including interface circuitry). The bus 110 may be a circuit designed for connecting the above-discussed elements and communicating data (e.g., a control message) between such elements. The processor 120 may receive commands from the other elements (e.g., the memory 130, the input/output interface 150, the display 160, or the communication interface 170, etc.) through the bus 110, interpret the received commands, and perform the arithmetic or data processing based on the interpreted commands. The memory 130 may store therein commands or data received from or created at the processor 120 or other elements (e.g., the input/output interface 150, the display 160, or the communication interface 170, etc.). The memory 130 may include programming modules 140 such as a kernel(s) 141, a middleware 143, an application programming interface (API) 145, and an application(s) 147. Each of the programming modules may be composed of software, firmware, hardware, and any combination thereof.

The kernel 141, as illustrated in FIG. 1, may control or manage system resources (e.g., the bus 110, the processor 120, the memory 130, etc.) used to execute operations or functions implemented by other programming modules (e.g., the middleware 143, the API 145, and the application 147). Also, the kernel 141 may provide an interface capable of accessing and controlling or managing the individual elements of the electronic device 101 by using the middleware 143, the API 145, or the application 147.

The middleware 143 may serve to go between the API 145 or the application 147 and the kernel 141 in such a manner that the API 145 or the application 147 communicates with the kernel 141 and exchanges data therewith. Also, in relation to work requests received from one or more applications 147 and/or the middleware 143, for example, may perform load balancing of the work requests by using a method of assigning a priority, in which system resources (e.g., the bus 110, the processor 120, the memory 130, etc.) of the electronic device 101 can be used, to at least one of the one or more applications 147. The API 145 is an interface through which the application 147 is capable of controlling a function provided by the kernel 141 or the middleware 143, and may include, for example, at least one interface or function for file control, window control, image processing, character control, or the like. The input/output interface 150 may deliver commands or data, entered by a user through an input/output unit or device (e.g., a sensor, a keyboard, or a touch screen), to the processor 120, the memory 130, or the communication interface 170 via the bus 110.

The display module 160 may include, for example, a liquid crystal display (LCD), a light emitting diode (LED) display, an organic LED (OLED) display, a micro electro mechanical system (MEMS) display, or an electronic paper display. The display 160 may display various types of contents (e.g., text, images, videos, icons, or symbols) for users. The display module 160 may include a touch screen, and may receive, for example, a touch, gesture, proximity, or hovering input by using an electronic device or a part of the user's body.

The communication interface 170, including interface circuitry, may establish communication between the electronic device 101 and any external device (e.g., the first external electronic device 102, the second external electronic device 104, and/or the server 106). For example, the communication interface 170 may be connected with a network 162 through wired or wireless communication 164 and thereby communicate with any external device (e.g., the second external electronic device 104, and/or the server 106).

Wireless communication (e.g., see 164) may use, as cellular communication protocol, at least one of long-term evolution (LTE), LTE advanced (LTE-A), code division multiple access (CDMA), wideband CDMA (WCDMA), universal mobile telecommunications system (UMTS), wireless broadband (WiBro), global system for mobile communications (GSM), and the like, for example. A short-range communication may include, for example, at least one of Wi-Fi, Bluetooth (BT), near field communication (NFC), magnetic secure transmission or near field magnetic data stripe transmission (MST), and GNSS, and the like. The GNSS may include at least one of, for example, a global positioning system (GPS), a global navigation satellite system (GLONASS), a BeiDou navigation satellite system (hereinafter, referred to as “BeiDou”), and Galileo (European global satellite-based navigation system). Hereinafter, the “GPS” may be interchangeably used with the “GNSS” in the present disclosure.

The wired communication may include, but not limited to, at least one of universal serial bus (USB), high definition multimedia interface (HDMI), recommended standard 232 (RS-232), or plain old telephone service (POTS). The network 162 includes, as a telecommunications network at least one of a computer network (e.g., local area network (LAN) or wide area network (WAN)), the internet, and a telephone network. The types of the first and second external electronic devices 102 and 104 may be the same as or different from the type of the electronic device 101. The server 106 may include a group of one or more servers. A portion or all of operations performed in the electronic device 101 may be performed in one or more other electronic devices 102 or 104 or the server 106. In the case where the electronic device 101 performs a certain function or service automatically or in response to a request, the electronic device 101 may request at least a portion of functions related to the function or service from another electronic device 102 or 104 or the server 106 instead of or in addition to performing the function or service for itself. The other electronic device 102 or 104 or the server 106 may perform the requested function or additional function, and may transfer a result of the performance to the electronic device 101. The electronic device 101 may additionally process the received result to provide the requested function or service. To this end, for example, a cloud computing technology, a distributed computing technology, or a client-server computing technology may be used.

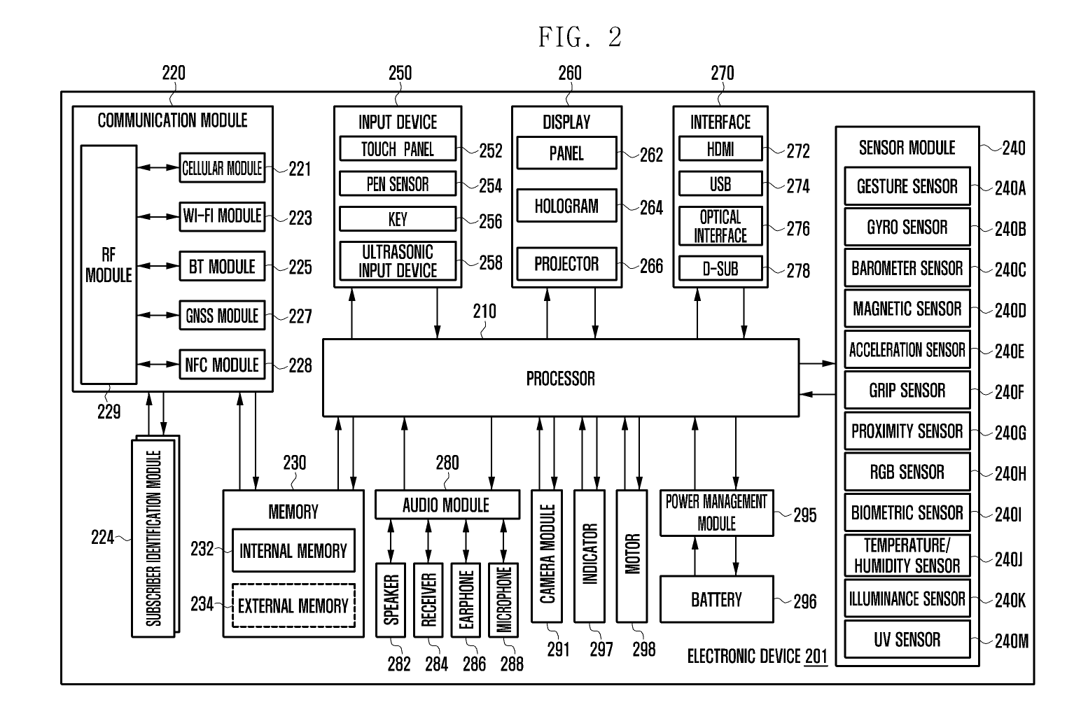

FIG. 2 is a block diagram illustrating an electronic device 201 (or 101) according to various example embodiments of the present disclosure. The electronic device 201 may form, for example, the whole or part of the electronic device 101 shown in FIG. 1.

Referring to FIG. 2, the electronic device 201 (or 101) may include at least one AP 210 (including processing circuitry), a communication module 220, a subscriber identification module (SIM) card 224, a memory 230, a sensor module 240 (including sensing circuitry), an input unit or input device 250 (including input/output circuitry), a display or display module 260, an interface 270 (including interface circuitry), an audio module 280, a camera module 291, a power management module 295, a battery 296, an indicator 297, and a motor 298. The processor 210 is capable of driving, for example, an operating system or an application program to control a plurality of hardware or software components connected to the processor 210, processing various data, and performing operations. The processor 210 may be implemented as, for example, a system on chip (SoC). According to an example embodiment, the processor 210 may further include a graphics processing unit (GPU) and/or an image signal processor.

The processor 210 may also include at least part of the components shown in FIG. 2, e.g., a cellular module 221. The processor 210 is capable of loading commands or data received from at least one of other components (e.g., a non-volatile memory) on a volatile memory, processing the loaded commands or data. The processor 210 is capable of storing various data in a non-volatile memory. The communication module 220 (e.g., the communication interface 170) may perform a data communication with any other electronic device (e.g., the electronic device 104 or the server 106) connected to the electronic device 201 (e.g., the electronic device 101) through the network. According to an example embodiment, the communication module 220 may include therein a cellular module 221, a Wi-Fi module 223, a BT module 225, a GNSS or GPS module 227, an NFC module 228, and a radio frequency (RF) module 229. The cellular module 221 is capable of providing a voice call, a video call, a short message service (SMS), an internet service, etc., through a communication network, for example. According to an example embodiment, the cellular module 221 is capable of identifying and authenticating an electronic device 201 in a communication network by using a SIM 224 (e.g., a SIM card). According to an example embodiment, the cellular module 221 is capable of performing at least part of the functions provided by the processor 210. According to an example embodiment, the cellular module 221 is also capable of including a communication processor (CP).

As illustrated in FIG. 2, the Wi-Fi module 223, the BT module 225, the GNSS module 227, and the NFC module 228 are each capable of including a processor for processing data transmitted or received through the corresponding module.

The MST module 228 is capable of including a processor for processing data transmitted or received through the corresponding module. According to various example embodiments, at least part of the cellular module 221, Wi-Fi module 223, BT module 225, GNSS module 227, NFC module 228, and MST module (e.g., two or more modules) may be included in one integrated chip (IC) or one IC package. The RF module 229 is capable of transmission/reception of communication signals, e.g., RF signals. The RF module 229 is capable of including a transceiver, a power amp module (PAM), a frequency filter, a low noise amplifier (LNA), an antenna, etc. According to an example embodiment, at least one of the cellular module 221, the Wi-Fi module 223, the BT module 225, the GNSS module 227, and the NFC module 228 is capable of transmission/reception of RF signals through a separate RF module. The SIM module 224 is capable of including a card including a SIM and/or an embodied SIM. The SIM module 224 is also capable of containing unique identification information, e.g., integrated circuit card identifier (ICCID), or subscriber information, e.g., international mobile subscriber identity (IMSI).

As illustrated in FIG. 2, memory 230 (e.g., memory 103 shown in FIG. 1) is capable of including a built-in or internal memory 232 and/or an external memory 234. The built-in or internal memory 232 is capable of including at least one of the following: a volatile memory, e.g., a dynamic random access memory (DRAM), a static RAM (SRAM), a synchronous dynamic RAM (SDRAM), etc.; and a non-volatile memory, e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., an NAND flash memory, an NOR flash memory, etc.), a hard drive, a solid state drive (SSD), etc.

The sensor module 240 is capable of measuring/detecting a physical quantity or an operation state of the electronic device 201, and converting the measured or detected information into an electronic signal. The sensor module 240 is capable of including at least one of the following: a gesture sensor 240A, a gyro sensor 240B, an atmospheric pressure or barometer sensor 240C, a magnetic sensor 240D, an acceleration sensor 240E, a grip sensor 240F, a proximity sensor 240G, a color or RGB sensor 240H (e.g., a red, green and blue (RGB) sensor), a biometric sensor 240I, a temperature/humidity sensor 240J, an illuminance sensor 240K, and an ultraviolet (UV) sensor 240M.

Additionally or alternatively, the sensor module 240 is capable of further including on or more of the following sensors or operations (not shown): an electronic nose (E-nose) sensor, an electromyography (EMG) sensor, an electroencephalogram (EEG) sensor, an electrocardiogram (ECG) sensor, an infrared (IR) sensor, an iris sensor and/or a fingerprint sensor. The sensor module 240 is capable of further including a control circuit for controlling one or more sensors included therein.

In various example embodiments of the present disclosure, the electronic device 201 is capable of including a processor, configured as part of the processor 210 or a separate component, for controlling the sensor module 240. In this case, while the processor 210 is operating in a sleep mode, the processor is capable of controlling the sensor module 240. The input device 250 is capable of including a touch panel 252, a (digital) pen sensor (digital pen or stylus) 254, a key 256, or an ultrasonic input unit or device 258. The touch panel 252 may be implemented with at least one of the following: a capacitive touch system, a resistive touch system, an infrared touch system, and an ultrasonic touch system. The touch panel 252 may further include a control circuit. The touch panel 252 may also further include a tactile layer to provide a tactile response to the user. The (digital) pen sensor 254 may be implemented with a part of the touch panel or with a separate recognition sheet. The key 256 may include a physical button, an optical key, or a keypad. The ultrasonic input unit 258 is capable of detecting ultrasonic waves, created in an input tool, through a microphone 288, and identifying data corresponding to the detected ultrasonic waves.

The display 260 (e.g., the display 106 shown in FIG. 1) is capable of including a panel 262, a hologram unit or device 264, or a projector 266. The panel 262 (e.g., LCD panel, LED panel, etc.) may include the same or similar configurations as the display 106 shown in FIG. 1. The panel 262 may be implemented to be flexible, transparent, or wearable.

The panel 262 may also be incorporated into one module together with the touch panel 252. The hologram unit 264 is capable of showing a stereoscopic image in the air by using light interference. The projector 266 is capable of displaying an image by projecting light onto a screen. The screen may be located inside or outside of the electronic device 201. According to an example embodiment, the display 260 may further include a control circuit for controlling the panel 262, the hologram unit 264, or the projector 266.

The interface 270, including interface circuitry, is capable of including an HDMI 272, a USB 274, an optical interface 276, or a D-subminiature (D-sub) 278. The interface 270 may be included in the communication interface 107 shown in FIG. 1. Additionally or alternatively, the interface 270 is capable of including a mobile high-definition link (MHL) interface, an SD card/MMC interface, or an infrared data association (IrDA) standard interface.

The audio module 280, as illustrated in FIG. 2, is capable of providing bidirectional conversion between a sound and an electronic signal. At least part of the components in the audio module 280 may be included in the input/output interface 145 shown in FIG. 1. The audio module 280 is also capable of processing sound information input or output through a speaker 282, a receiver 284, earphones 286, microphone 288, etc.

The camera module 291 refers to a device capable of taking both still and moving images. According to an example embodiment, the camera module 291 is capable of including one or more image sensors (e.g., a front image sensor or a rear image sensor), a lens, an image signal processor (ISP), a flash (e.g., an LED or xenon lamp), etc.

The power management module 295 is capable of managing power of the electronic device 201. According to an example embodiment, the power management module 295 is capable of including a power management IC (PMIC), a charger IC, or a battery or fuel gauge. The PMIC may employ wired charging and/or wireless charging methods. Examples of the wireless charging method are magnetic resonance charging, magnetic induction charging, and electromagnetic charging. To this end, the PIMC may further include an additional circuit for wireless charging, such as a coil loop, a resonance circuit, a rectifier, etc. The battery gauge is capable of measuring the residual capacity, charge in voltage, current, or temperature of the battery 296. The battery 296 takes the form of either a rechargeable battery or a solar battery.

The indicator 297 is capable of displaying a specific status of the electronic device 201 or a part thereof (e.g., the processor 210), e.g., a boot-up status, a message status, a charging status, etc. The motor 298 is capable of converting an electrical signal into mechanical vibrations, such as, a vibration effect, a haptic effect, etc. Although not shown, the electronic device 201 is capable of further including a processing unit (e.g., GPU) for supporting a mobile TV. The processing unit for supporting a mobile TV is capable of processing media data pursuant to standards, e.g., digital multimedia broadcasting (DMB), digital video broadcasting (DVB), or mediaFlo™ etc.

Each of the elements described in the present disclosure may be formed with one or more components, and the names of the corresponding elements may vary according to the type of the electronic device. In various example embodiments, the electronic device may include at least one of the above described elements described in the present disclosure, and may exclude some of the elements or further include other additional elements. Further, some of the elements of the electronic device according to various example embodiments may be coupled to form a single entity while performing the same functions as those of the corresponding elements before the coupling.

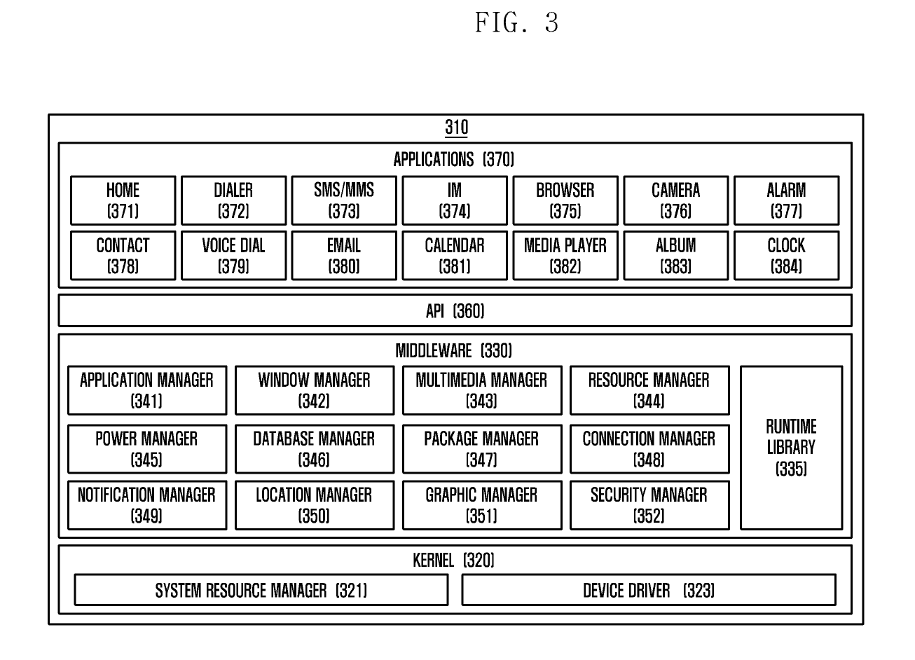

FIG. 3 is a block diagram illustrating a configuration of a programming module 310 according to various example embodiments of the present disclosure.

The programming module 310 may be included (or stored) in the electronic device 100 (e.g., the memory 130) illustrated in FIG. 1, or may be included (or stored) in the electronic device 201 (e.g., the memory 230) illustrated in FIG. 2. At least a part of the programming module 310 may be implemented in software, firmware, hardware, or a combination of two or more thereof. The programming module 310 may be implemented in hardware (e.g., the hardware 200 of FIG. 2), and may include an operating system (OS) controlling resources related to an electronic device (e.g., the electronic device 100) and/or various applications (e.g., an application 370) executed in the OS. For example, the OS may be Android, iOS, Windows, Symbian, Tizen, Bada, and the like.

Referring to FIG. 3, the programming module 310 may include a kernel 320, a middleware 330, an API 360, and/or the application 370.

The kernel 320 (e.g., the kernel 141 in FIG. 1) may include a system resource manager 321 and/or a device driver 323. The system resource manager 321 may include, for example, a process manager (not illustrated), a memory manager (not illustrated), and a file system manager (not illustrated). The system resource manager 321 may perform the control, allocation, recovery, and/or the like of system resources. The device driver 323 may include, for example, a display driver (not illustrated), a camera driver (not illustrated), a BT driver (not illustrated), a shared memory driver (not illustrated), a USB driver (not illustrated), a keypad driver (not illustrated), a Wi-Fi driver (not illustrated), and/or an audio driver (not illustrated). Also, according to an example embodiment of the present disclosure, the device driver 312 may include an inter-process communication (IPC) driver (not illustrated).

The middleware 330 may include multiple modules previously implemented so as to provide a function used in common by the applications 370. Also, the middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity or connection manager 348, a notification manager 349, a location manager 350, a graphic manager 351, a security manager 352, and any other suitable and/or similar manager(s).

The runtime library 335 may include, for example, a library module used by a complier, in order to add a new function by using a programming language during the execution of the application(s) 370. According to an example embodiment of the present disclosure, the runtime library 335 may perform functions which are related to input and output, the management of a memory, an arithmetic function, and/or the like.

The application manager 341 may manage, for example, a life cycle of at least one of the applications 370. The window manager 342 may manage graphical user interface (GUI) resources used on the screen. The multimedia manager 343 may detect a format used to reproduce various media files and may encode or decode a media file through a codec appropriate for the relevant format. The resource manager 344 may manage resources, such as a source code, a memory, a storage space, and/or the like of at least one of the applications 370.

The power manager 345, as illustrated in FIG. 3, may operate together with a basic input/output system (BIOS), may manage a battery or power, and may provide power information and the like used for an operation. The database manager 346 may manage a database in such a manner as to enable the generation, search and/or change of the database to be used by at least one of the applications 370. The package manager 347 may manage the installation and/or update of an application distributed in the form of a package file.

The connectivity or connection manager 348 may manage a wireless connectivity such as, for example, Wi-Fi and BT. The notification manager 349 may display or report, to the user, an event such as an arrival message, an appointment, a proximity alarm, and the like in such a manner as not to disturb the user. The location manager 350 may manage location information of the electronic device. The graphic manager 351 may manage a graphic effect, which is to be provided to the user, and/or a user interface related to the graphic effect. The security manager 352 may provide various security functions used for system security, user authentication, and the like. According to an example embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. Also, the middleware 330 may dynamically delete some of the existing elements, or may add new elements. Accordingly, the middleware 330 may omit some of the elements described in the various example embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a short message service (SMS)/multimedia message service (MMS) application 373, an instant message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application(s).

At least a part of the programming module 310 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 310 may be implemented (e.g., executed) by, for example, the one or more processors 210. At least a part of the programming module 310 may include, for example, a module, a program, a routine, a set of instructions, and/or a process for performing one or more functions.

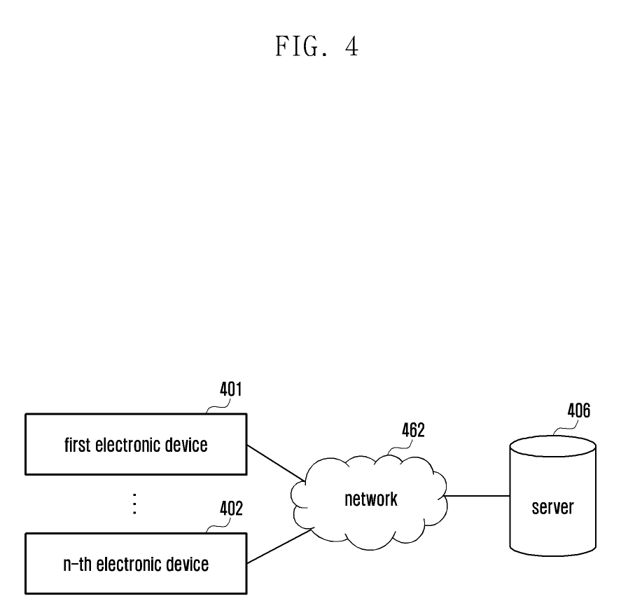

FIG. 4 is a diagram illustrating the configuration of a system according to various example embodiments of the present disclosure.

Referring to the system diagram of FIG. 4, the system may include first to n-th electronic devices 401 to 402 and a server 406. On the system, the first to n-th electronic devices 401 to 402 and the server 406 may be connected to each other through a network 462. The electronic devices 401-402 may be, for example, the electronic devices 101, 201 shown and described in connection with FIGS. 1-2.

According to various example embodiments, at least one of the first to n-th electronic devices 401 to 402 may be a master electronic device in generating a group. In FIG. 4, the first electronic device 401 may be a master electronic device. Electronic devices excluding the master electronic device may be called slave electronic devices.

In the following description, from the viewpoint of the master electronic device and the slave electronic device, all other electronic devices may be described as external electronic devices. For example, in the case of a plurality of master electronic devices, external electronic devices of the master electronic devices may include one other master electronic device and slave electronic devices. In the case of a single master electronic device, it may include slave electronic devices. Further, in the case of a plurality of slave electronic devices, external electronic devices of the slave electronic devices may include a master electronic device and remaining slave electronic devices. In the case of a single slave electronic device, external electronic devices of the slave electronic device may include a master electronic device and a remaining slave electronic device.

In an example embodiment of the present disclosure, the master electronic device (e.g., 401) may set schedule information, and may generate a group to share the schedule information. Further, the master electronic device may transmit the schedule information to external electronic devices corresponding to the generated group, and may request the external electronic devices to approve group generation. The master electronic device may transmit the schedule information to the external electronic devices through the network, and may request the external electronic devices to approve the group generation. According to various example embodiments, the master electronic device may pre-store user information of the slave electronic devices related to the group generation in a memory. As another example embodiment, the master electronic device may receive the user information of the slave electronic devices related to the group generation from the slave electronic devices or a server.

In an example embodiment of the present disclosure, the master electronic device may display a user interface including the schedule information and the user information of the external electronic devices that have approved the group generation. The master electronic device may share event information with the external electronic devices, and may display the event information received from the external electronic devices.

In an example embodiment of the present disclosure, the event information may include information indicating one of sound, release, and suspension of an alert related to the schedule in an electronic device and/or external electronic device.

In an example embodiment of the present disclosure, the event information may include connection information received through communication between an electronic device and/or external electronic device and a second external electronic device. For example, the second external electronic device may include an internet of things (IoT) device and a connected car, and the connection information may include distance information between an electronic device and/or external electronic device communicating with the IoT device. Further, the connection information may include GPS information that an electronic device and/or external electronic device communicating with the connected car receives from the connected car.

In an example embodiment of the present disclosure, the event information may include information sensed by sensors of an electronic device and/or external electronic device. The sensors may include one or more of sensor modules or sensors of FIG. 2.

In an example embodiment of the present disclosure, the event information may include communication event information. The communication event information may include a voice signal received by an electronic device and/or external electronic device to transmit a voice message through the user interface, or a text received to transmit a message.

In an example embodiment of the present disclosure, the event information may include payment service information. The payment service information may include information related to the details of the payment received through an electronic device and/or external electronic device.

In various example embodiments of the present disclosure, a slave electronic device that is not a master electronic device may be, for example, one of the second to n-th electronic devices 402 in FIG. 4. The slave electronic device (e.g., 402) may receive the generated schedule information and a request for group generation approval from the master electronic device (e.g., 401) that has generated the schedule information.

In an example embodiment of the present disclosure, if the slave electronic device has approved the group generation, it may transmit a group generation approval alert to a server or an external electronic device, and may display a user interface. In various example embodiments, the slave electronic device may receive from the master electronic device and/or the server the user information of the external electronic devices related to the group generation. As another example embodiment, the slave electronic device may pre-store the user information of the external electronic devices related to the group generation in the memory. The slave electronic device may share the event information with the external electronic device, and may display the event information received from the external electronic devices.

The server 406 of FIG. 4 may be a server related to a schedule related application. The server 406 may include at least a partial configuration of the server 106 of FIG. 1. The server 406 may store therein the user information of the electronic devices and the schedule information. Further, the server 406 may transmit information or the like to the external electronic devices in accordance with a request from the electronic device(s) 401, 402. Further, the server 406 may receive an approval alert of the electronic device that has approved the group generation, and may transmit the received approval alert to other external electronic devices.

In an example embodiment of the present disclosure, the server 406 may generate the group in accordance with the request for group generation from the master electronic device, and may transmit a request for group generation approval to the external electronic device. The user information may include identification information for identifying the electronic device or the user who uses the electronic device. For example, the user information may include the name of the user who uses the electronic device, the name of the electronic device, and account information subscribed when the schedule related application requests the subscription. Further, the user information may include at least a part of the schedule information. Further, the user information may include sensing information of the electronic devices. For example, the sensing information may include location information of the electronic devices.

In various example embodiments of the present disclosure, an electronic device may include a display including a touch screen; a communication unit configured to communicate with a server, an external electronic device, and a second external electronic device; a sensor unit; a processor; and a memory electrically connected to the processor, wherein the memory, when executed, stores instructions to cause the processor to set schedule information, to generate a group to share the schedule information, to control the communication unit to request external electronic devices related to the generated group to approve group generation, to control the display to display a user interface including the schedule information and user information of the external electronic devices that have approved the group generation, to control the communication unit to receive event information from the external electronic devices, and to control the display to display the received event information.

In various example embodiments of the present disclosure, the memory may store instructions to display an alert if time of the schedule information arrives.

In various example embodiments of the present disclosure, the memory may store instructions to control the communication unit to transmit event information related to a generated event to the external electronic devices if the event is generated by the electronic device. In various example embodiments of the present disclosure, the event information may include connection information with the second external electronic device, and the connection information with the second external electronic device may include distance information calculated through communication with the second external electronic device and GPS information received from the peripheral device.

In various example embodiments of the present disclosure, the second external electronic device may include an internet of things (IoT) device and a connected car.

In various example embodiments of the present disclosure, the event information may include operation information related to the schedule information, and the operation information related to the schedule information may include information indicating one of release and suspension of an alert related to the schedule information.

In various example embodiments of the present disclosure, the event information may include sensing information, and the sensing information may include information received from sensors of the electronic device.

In various example embodiments of the present disclosure, the event information may include communication event information, and the communication event information may include a voice signal and text information received through the user interface.

In various example embodiments of the present disclosure, the event information may include payment service information, and the payment service information may include information related to payment details received through the electronic device.

In various example embodiments of the present disclosure, the memory may store instructions to generate the group based on the pre-stored user information of the external electronic devices.

In various example embodiments of the present disclosure, the user information may be identification information including name and account information.

In various example embodiments of the present disclosure, the memory may store instructions to control the communication unit to request the server to perform the group generation, and to receive from the server that has responded to the request the user information of the external electronic devices related to the group generated by the server.

In various example embodiments of the present disclosure, the group generated by the server may be a group set based on the user information of the external electronic devices preregistered in the server. In various example embodiments of the present disclosure, the memory may store instructions to transmit a message including the schedule information and the user information of the external electronic devices to the external electronic devices related to the generated group.

In various example embodiments of the present disclosure, the memory may store instructions to display a user interface including the schedule information and user information related to the external electronic devices that have approved the group generation.

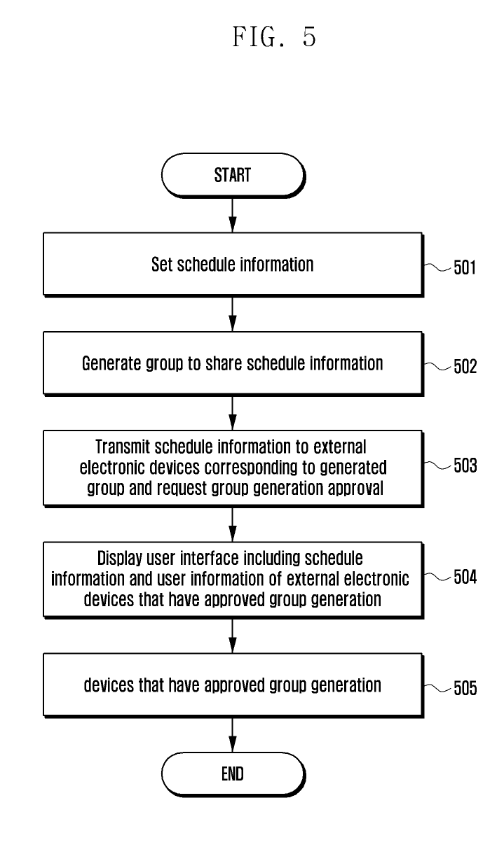

Hereinafter, a schedule sharing operation will be described with reference to FIGS. 5 to 7.

FIG. 5 is a flowchart illustrating a schedule sharing operation according to various example embodiments of the present disclosure.

At operation 501, a processor (e.g., 120, 210) of an electronic device (e.g., 101, 201, 401) may set schedule information. The electronic device that sets the schedule information may be a master electronic device.

At operation 502, the processor (e.g., 120, 210) of the electronic device (e.g., 101, 201, 401) may generate a group to share the schedule information. At operation 503, the processor (e.g., 120, 210) of the electronic device (e.g., 101, 201, 401) may transmit the schedule information to external electronic devices corresponding to the generated group, and may request a group generation approval.

In an example embodiment of the present disclosure, in generating the group to share the schedule information, the electronic device may generate the group through reception of user's selection input in a contact address pre-stored in the memory of the electronic device.

In another example embodiment, the electronic device may set the group that is preset in the contact address pre-stored in the memory of the electronic device as the group to share the schedule information.

In still another example embodiment, the electronic device may set the group based on calling frequencies in a call log database stored in the memory of the electronic device.

In an example embodiment of the present disclosure, in determining a user who will set the group, the electronic device may display the call log database in the form of a list. The electronic device may display the user having high calling frequency in the list in distinction from other users through color inversion or the like. The electronic device may receive a user's input for selecting at least one of users distinctively displayed, and may set the group based on the selected user. The user displayed in the call log database may include a part of the user information.

In another example embodiment, the electronic device may request a server connected to the electronic device to generate the group. In response to the request, the server may generate the group based on the user information pre-stored in the server, and may transmit a request for group generation approval to the external electronic device related to the group.

As another example, the server may generate the group in response to the request, and may transmit the user information that belongs to the group to the electronic device that has requested the group generation to enable the electronic device to confirm the group generated by the server.

In another example embodiment, the server may set the user information having the same schedule information as the group based on the schedule information among the user information of the electronic devices pre-stored in the server in response to the request.

At operation 504, the processor (e.g., 120, 210) of the electronic device (e.g., 101, 201, 401) may display a user interface including the schedule information and the user information of the external electronic devices that have approved the group generation.

In an example embodiment of the present disclosure, the electronic device may display the schedule information on one portion of the user interface and may display the user information related to the group on the other portion. In an example embodiment, the electronic device may display user's name that is a part of the user information.

At operation 505, the processor (e.g., 120, 210) of the electronic device (e.g., 101, 201, 401) may share event information with the external electronic devices to display the shared event information.

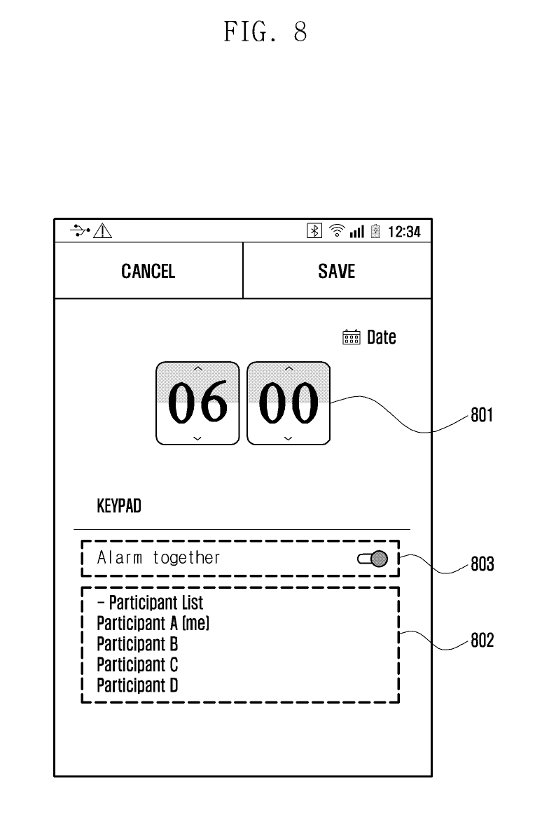

In an example embodiment, the electronic device may share the event information with the external electronic devices through the user interface. Further, the electronic device may display the event information received from the external electronic devices through the user interface. For example, in displaying the event information through the user interface, the electronic device may display the user information related to the external electronic device that has transmitted the event information, and may display the event information together in the neighborhood of the user information. Explanation related to the user interface, including interface circuitry, will be made with reference to FIGS. 8 to 13.

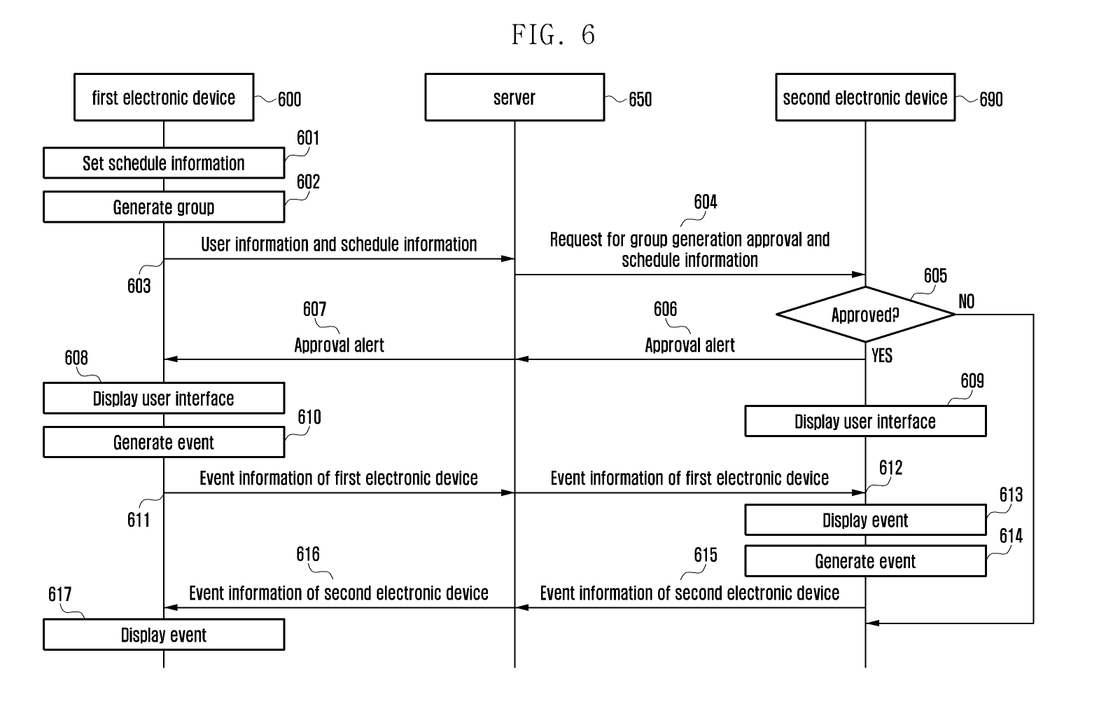

FIG. 6 is a sequence diagram illustrating a schedule sharing operation according to various example embodiments of the present disclosure.

Referring to FIG. 6, a first electronic device 600 (or 101, 201, 401) and a second electronic device 690 (or 101, 201, 402) may be connected to a server 650 (or 106, 406). The first electronic device 600 may be a master electronic device configured to set schedule information, and the second electronic device 690 may be an external electronic device configured to receive the schedule information, for example, a slave electronic device.

At operation 601, the first electronic device 600 may set the schedule information.

At operation 602, the first electronic device 600 may generate a group to share the schedule information. At operation 603, the first electronic device 600 may transmit user information of the electronic devices related to the group and the schedule information to the server 650.

At operation 604, the server 650 may process a request for group generation approval to the second electronic device(s) 690 based on the user information of the electronic devices related to the group received from the first electronic device 600. Together with the request, the server 650 may transmit 604 the schedule information received from the first electronic device 600.

If the second electronic device(s) 690 approves the request at operation 605, it may transmit an approval alert to the server 650 at operation 606, and the server 650 may transmit the approval alert to the first electronic device 600 at operation 607.

In various example embodiments, the first electronic device 600 that has generated the group may store therein the user information of the electronic devices related to the group. The second electronic device 690 that has received the request for group generation approval need not store therein the user information of the electronic devices related to the group. At operation 603, the first electronic device 600 may transmit the user information of the electronic devices related to the group and the schedule information. Accordingly, at operation 604, the server 650 may transmit not only the request for group generation approval and the schedule information but also the user information of the electronic devices related to the group to the second electronic device(s) 690.

At operation 608, the first electronic device 600 that has received the group generation approval alert of the second electronic device 690 may display the user interface including the schedule information and the user information. At operation 609, the second electronic device(s) 690 that has/have approved the group generation may display the user interface including the schedule information and the user information.

If the first electronic device 600 senses event generation at operation 610, it may transmit event information related to the sensed event (e.g., time and place for a meeting) to the server 650 to transmit the event information to the second electronic device(s) 690 at operation 611. At operation 612, the server 650 may transmit the received event information of the first electronic device 600 to the second electronic device(s) 690. At operation 613, the second electronic device 690 may display the received event information on the user interface of the second electronic device.

If the second electronic device 690 senses the event generation at operation 614, it may transmit the event information related to the sensed event to the server 650 to transmit the event information to the first electronic device 600 at operation 615. At operation 616, the server 650 may transmit the received event information of the second electronic device 690 to the first electronic device 600. At operation 617, the first electronic device 600 may display the received event information on the user interface.

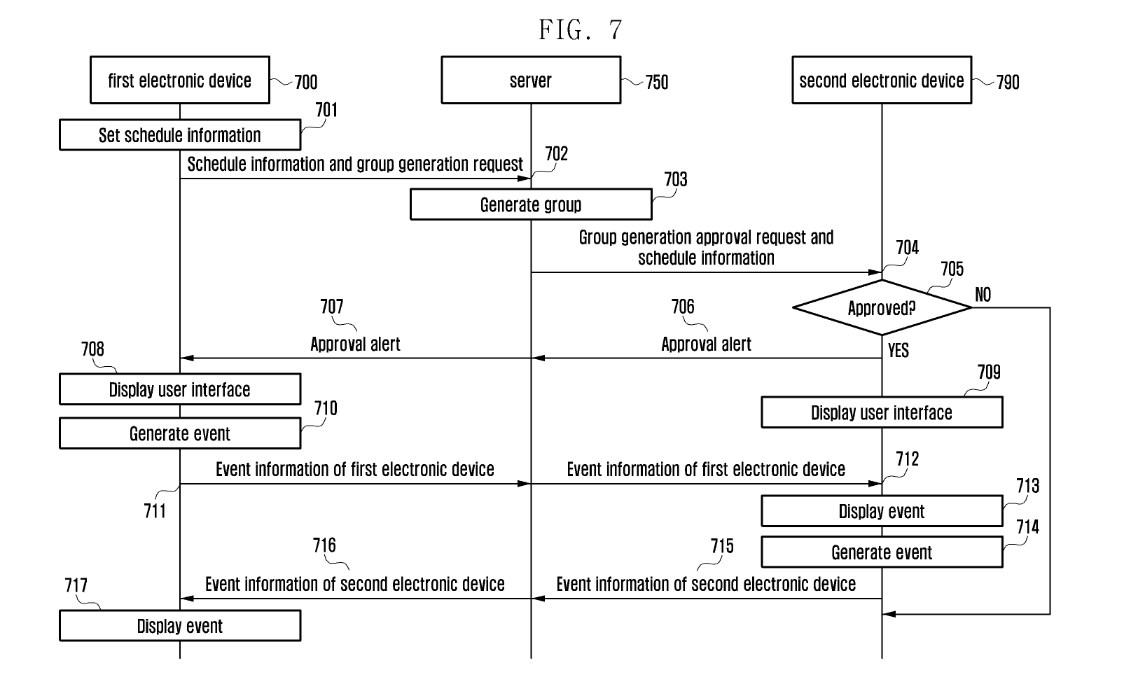

FIG. 7 is a sequence diagram illustrating a schedule sharing operation according to various example embodiments of the present disclosure.

Referring to FIG. 7, a first electronic device 700 (or 101, 201, 401, 600) and a second electronic device 790 (or 101, 201, 402, 690) may be connected to a server 750 (e.g., 106, 406, 650). The first electronic device 700 may be a master electronic device configured to set schedule information, and the second electronic device 790 may be an external electronic device configured to receive the schedule information, for example, a slave electronic device.

At operation 701, the first electronic device 700 may set the schedule information.

At operation 702, the first electronic device 700 may request the server 750 to generate a group to share the schedule information. Further, the first electronic device 700 may transmit the schedule information together with the request. In various example embodiments, the server 750 may store therein user information related to not only the first electronic device 700 and the second electronic device 790, but also other electronic devices. At operation 703, the server 750 may set the group in response to a request for group generation of the first electronic device 700 based on the user information and/or other data stored in the server 750.

As another example embodiment, the server 750 may set users having the same schedule information as the group to generate the group based on the schedule information among the user information of the electronic devices pre-stored in the server 750. The user information may include at least a part of the schedule information.

At operation 704, the server 750 may transmit the schedule information to the second electronic device(s) 790, and may request group generation approval. The second electronic device(s) 790 may be one or more of electronic devices that belong to the group generated by the server 750.

If the second electronic device 790 approves the request at operation 705, it may transmit an approval alert to the server 750 at operation 706, and the server 750 may transmit the approval alert to the first electronic device 700 at operation 707.

In various example embodiments, the first electronic device 700 that has requested the group generation and/or the second electronic device 790 that has received the request for group generation approval may, or may not, not store therein the user information of the electronic devices related to the group.

In an example embodiment of the present disclosure, the server 750, at operation 706, may also transmit the user information of the electronic devices related to the group to the second electronic device 790 when it receives the approval alert from the second electronic device 790. Further, at operation 707, the server 750 may transmit the user information of the electronic devices related to the group to the first electronic device 700 when it transmits the approval alert to the first electronic device 700.

In various example embodiments, after generating the group and approval thereof at operation 705, the server 750 may transmit the user information of the electronic devices related to the generated group to the first electronic device 700 that has requested the group generation (e.g., at 707), so that the first electronic device 700 can confirm the electronic devices that belong to the group generated by the server 750.

At operation 708, the first electronic device 700 that has received the group generation approval alert of the second electronic device 790 may display the user interface, including the schedule information and the user information. At operation 709, the second electronic device 790 that has approved the group generation may display the user interface including the schedule information and the user information.

If the first electronic device 700 senses event generation at operation 710, it may transmit event information related to the sensed event to the server 750 to transmit the event information to the second electronic device(s) 790 at operation 711. At operation 712, the server 750 may transmit the received event information of the first electronic device 700 to the second electronic device(s) 790. At operation 713, the second electronic device 790 may display the received event information on the user interface.

If the second electronic device 790 senses the event generation at operation 714, it may transmit the event information related to the sensed event to the server 750 to transmit the event information to the first electronic device 700 at operation 715. At operation 716, the server 750 may transmit the received event information of the second electronic device 790 to the first electronic device 700. At operation 717, the first electronic device 700 may display the received event information on the user interface.

In various example embodiments of the present disclosure, a method for sharing a schedule in an electronic device may include setting schedule information; generating a group to share the schedule information; requesting external electronic devices related to the generated group to approve group generation; displaying a user interface including the schedule information and user information of the external electronic devices that have approved the group generation; and displaying event information received from the external electronic devices on the user interface.

In various example embodiments of the present disclosure, the method may further include displaying an alert if time of the schedule information arrives.

In various example embodiments of the present disclosure, the method may further include transmitting event information related to a generated event to the external electronic devices if the event is generated by the electronic device.

In various example embodiments of the present disclosure, the event information may include connection information with a second external electronic device, and the connection information with the second external electronic device may include distance information calculated through communication with the second external electronic device and GPS information received from the peripheral device.

In various example embodiments of the present disclosure, the second external electronic device may include an internet of things (IoT) device and a connected car.

In various example embodiments of the present disclosure, the event information may include operation information related to the schedule information, and the operation information related to the schedule information may include information indicating one of release and suspension of an alert related to the schedule information.

In various example embodiments of the present disclosure, the event information may include sensing information, and the sensing information may include information received from sensors of the electronic device.

In various example embodiments of the present disclosure, the event information may include communication event information, and the communication event information may include a voice signal and text information received through the user interface.

In various example embodiments of the present disclosure, the event information may include payment service information, and the payment service information may include information related to payment details received through the electronic device.

In various example embodiments of the present disclosure, generating the group may include generating the group based on the pre-stored user information of the external electronic devices.

In various example embodiments of the present disclosure, the user information may be identification information including name and account information.

In various example embodiments of the present disclosure, generating the group may include requesting a server connected to the electronic device to perform the group generation; and receiving the user information of the external electronic devices related to the group generated by the server that has responded to the request.

In various example embodiments of the present disclosure, the group generated by the server may be set based on the user information of the external electronic devices preregistered in the server.

In various example embodiments of the present disclosure, requesting the group generation approval may include transmitting a message including the schedule information and the user information of the external electronic devices to the external electronic devices related to the generated group.

In various example embodiments of the present disclosure, displaying the interface may include displaying a user interface including the schedule information and user information related to the external electronic devices that have approved the group generation.

Referring to FIGS. 8 to 13, for convenience in explanation, an electronic device configured to generate schedule information as illustrated in FIGS. 6 and 7 is called a first electronic device, and an electronic device configured to receive a request for group generation approval is called a second electronic device.

FIG. 8 is an exemplary diagram for setting schedule information according to various example embodiments of the present disclosure.

In an example embodiment of the present disclosure, a first electronic device (e.g., 101, 201, 401, 600, 700) may display a user interface. The user interface of FIG. 8 may be a user interface displayed for a user to set schedule information. The user interface may include a region 801 in which time information among the schedule information can be set. The user interface may include a region 802 in which a group to share an alarm related to the schedule information is displayed. In the region 802 in which a group to share an alarm related to the schedule information is displayed, user information of electronic devices related to the group may be displayed. Although not illustrated in FIG. 8, the user interface may include not only the time information among the schedule information but also a region for setting date information and a region for setting an appointed place.

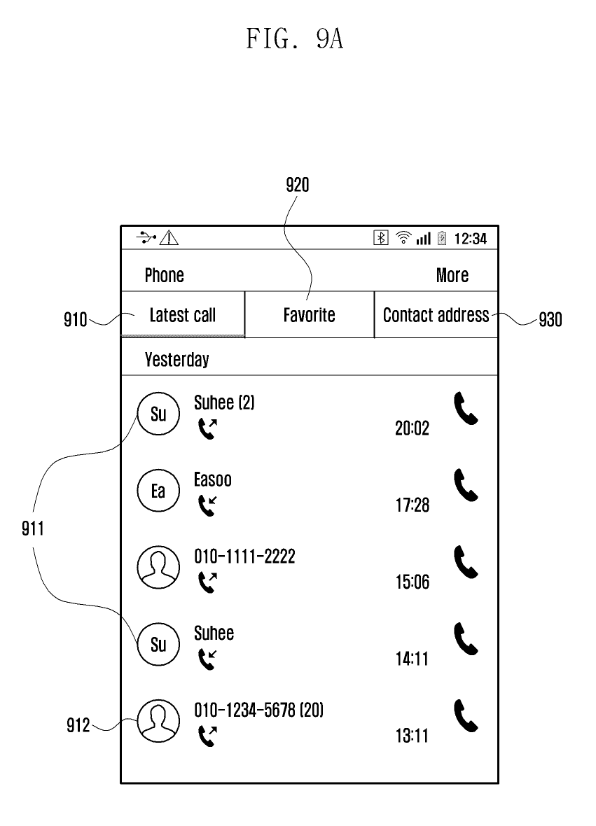

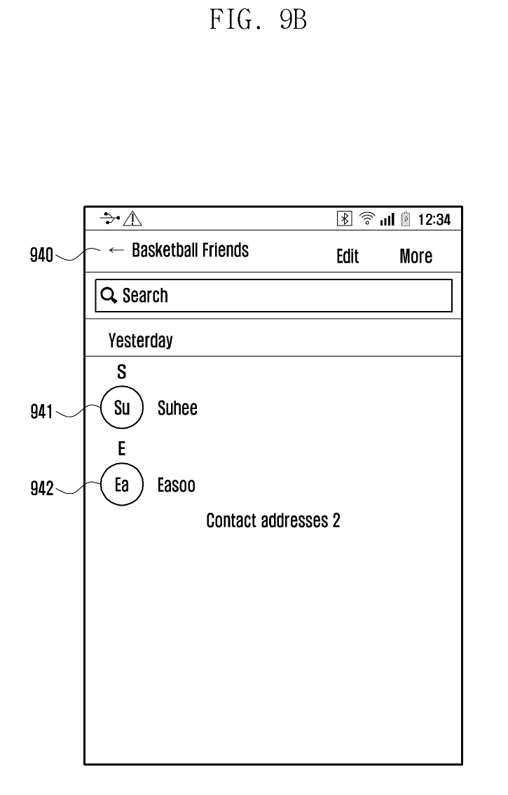

FIGS. 9A and 9B are exemplary diagrams for designating a group according to various example embodiments of the present disclosure.

FIGS. 9A and 9B may correspond to screens on which a phonebook application of a first electronic device (e.g., 101, 201, 401, 600, 700) has been executed. The phonebook application may include user information pre-stored in a memory of an electronic device. The user information may include a name and a contact address. The first electronic device may selectively display the user information related to latest call list 910, favorite 920, and contact address 930 in response to a user's selection input on the phonebook application.

The screen illustrated in FIG. 9A shows a latest call list 910. The first electronic device may set a group based on the user information selected through reception of the user's selection input on the displayed latest call list 910.

Further, in an example embodiment of the present disclosure, even if the user's selection input is not received, the first electronic device may set a group based on usage frequency on the latest call list 910 to display the group to the user. Referring to FIG. 9A, the screen shows a preset group in the memory of the electronic device. The preset group may be displayed, for example, on a phonebook application as illustrated in FIG. 9B. The preset group is a group called “Basketball Friends” 940, and group one may include “Suhee” 941 and “Easoo” 942. The electronic device (e.g., 101, 201, 401, 600, 700) may set the group as a group to share the schedule information. The group one may be user information of the electronic device related to the group.

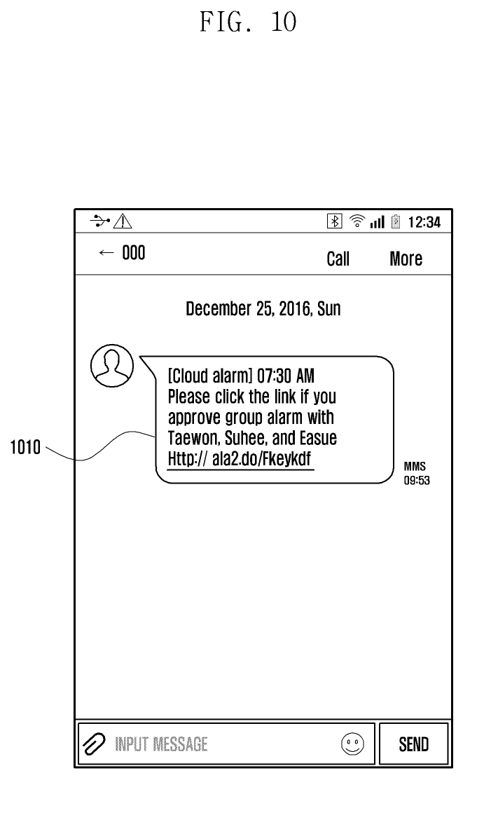

FIG. 10 is an exemplary diagram related to a request for group generation approval according to various example embodiments of the present disclosure.

In an example embodiment of the present disclosure, the first electronic device (e.g., 101, 201, 401, 600, 700) may transmit a message including schedule information and user information of electronic devices to be set as a group to the second electronic device. Referring to FIG. 10, the screen shows that the second electronic device (e.g., 101, 201, 402, 690, 790) has received the message 1010 from the first electronic device.

In various example embodiments of the present disclosure, the message 1010 may include data for a server (e.g., 106, 406, 650, 750) to determine whether the second electronic device (e.g., 101, 201, 402, 690, 790) that has received the message 1010 approves group generation. The second electronic device that has received the message 1010 may notify the server whether to approve the group generation through processing of the data included in the message 1010 by a user of the second electronic device or the system. In an example embodiment, in processing the data included in the message 1010 through the second electronic device, the data may be link type data, and the second electronic device may perform the group generation approval through connection to a link. The second electronic device may connect to the link, and may download and store the schedule information and the user information of the electronic devices to be set as the group through the server. Referring to FIG. 10, the link type data may include Http://al2.do/Fkeykdf in the message 1010.

In an example embodiment of the present disclosure, since the second electronic device that has received the message 1010 processes the data transferred through the message, the schedule information may be stored in the second electronic device, and an alarm for notifying of the schedule information may be set. Further, an application in which the schedule information is to be stored or an application to process the set alarm may be designated.

Further, through processing of the data, the second electronic device may execute a pre-designated application related to the data in a manner that it stores the schedule information and the user information of the electronic devices to be set as the group, and sets the alarm for notifying of the schedule information.

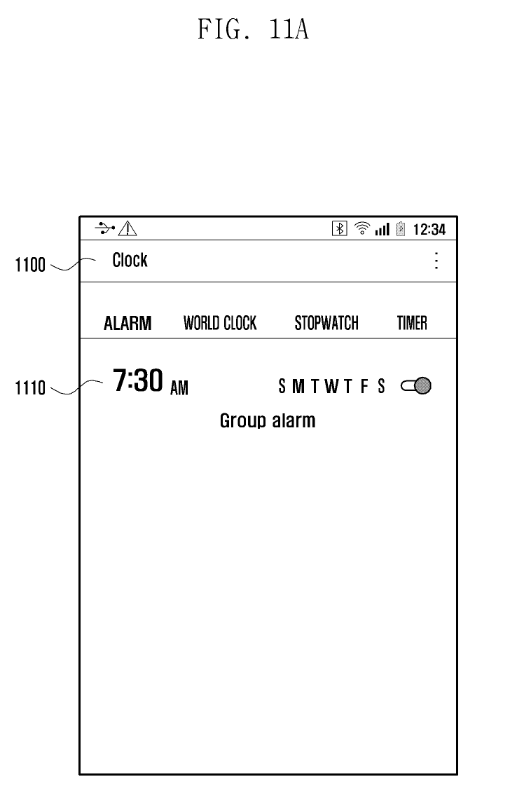

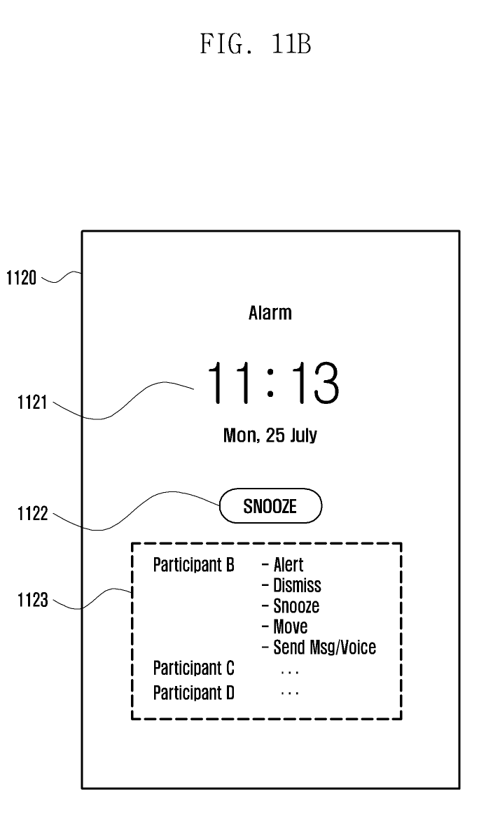

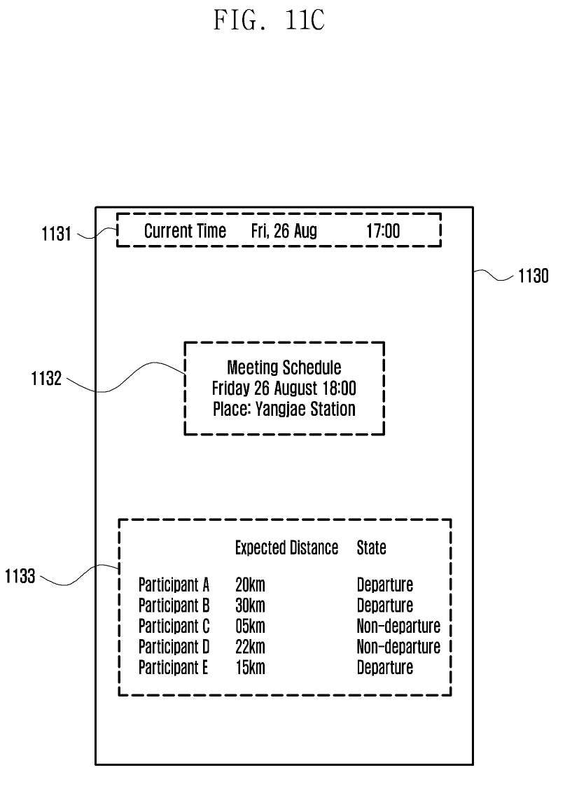

FIGS. 11A to 11C are diagrams illustrating a user interface according to various example embodiments of the present disclosure.

Referring to FIG. 11A, if the second electronic device responds to the request for group generation approval by processing the data included in the message through selection of the user of the second electronic device or processing of the system, the second electronic device (e.g., 101, 201, 402, 690, 790) may display the screen as illustrated in FIG. 11A. In the second electronic device, an application related to the schedule of the second electronic device may be executed, and the schedule information that has been transferred together when the group generation approval is requested through the schedule related application may be registered. The schedule related application may be an alarm application 1100, and time corresponding to 7:30 AM 1110 that is schedule information included in the message may be set.

In still another example embodiment, the user interface may include a region in which not only the schedule information but also the user information of the electronic devices that have approved the group generation request through the second electronic device. The first electronic device that has generated the schedule information and the second electronic device that has received the schedule information may display a user interface 1120 as illustrated in FIG. 11B.

For easy explanation, it is assumed that FIG. 11B illustrates a user interface displayed on the first electronic device (e.g., 101, 201, 401, 600, 700). Referring to FIG. 11B, the interface may display a schedule information display region 1121, an alert control region 1122, and the user information related to the set group, and may include an event sharing region 1123 in which event information can be shared with the electronic devices meant by user information, for example, the second electronic devices.

In an example embodiment, in the event sharing region 1123, shared event information for the second electronic devices may be displayed.

For example, among the event information illustrated in FIG. 11B, “Alert”, “Dismiss”, and “Snooze” may include information on alert generation, release, and suspension related to the schedule. Among the event information illustrated in FIG. 11B, “Move” is information indicating movement of the second electronic device, and may include information that is sensed through a sensor of the second electronic device and then is shared. Further, through connection between the second electronic device and an external electronic device, the event information may include a distance calculated between the second electronic device and the external electronic device. Further, the event information may include location information transmitted from the external electronic device. The external electronic device may include an IoT device and a connected car.

Further, as the event information, icons for sharing the event information between the respective electronic devices may be displayed. The icons displayed in an event sharing region of FIG. 11B are icons for sharing communication event information, and may include “Send Msg/Voice”. The icons may be icons for activating transmission of a voice message or a text message to be transmitted to the second electronic device.

In still another example embodiment, referring to FIG. 11C, the interface may display a current time display region, a schedule information display region, and an event sharing region. In the current time display region of FIG. 11C, the current time and date information may be displayed. In the schedule information display region, time information and location information of the schedule information may be displayed, and the event sharing region may be a region in which the user information related to the set group is displayed, and the event information is shared between the second electronic devices meant by the user information.

In an example embodiment of the present disclosure, in the event sharing region, the user information indicating the second electronic devices and location information of the second electronic devices indicated by the user information may be displayed as the event information. The location information may be displayed through calculation of a difference in distance between location information received from the second electronic devices and location of the schedule information. The location information of the second electronic device may be location information received from a location based sensor among sensors of the second electronic device.

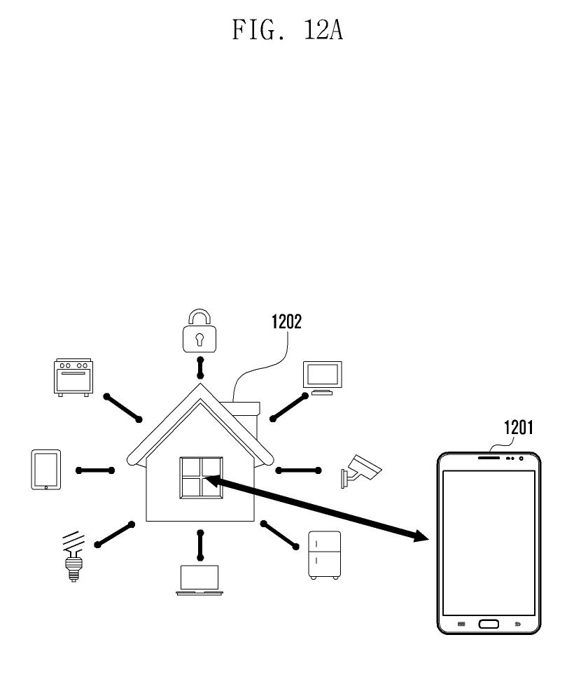

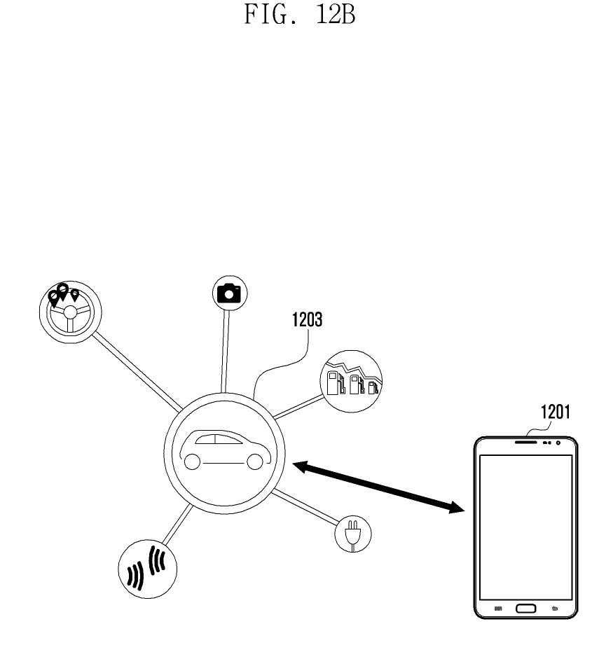

In an example embodiment of the present disclosure, as illustrated in FIG. 12A, the location information may be connection information between the second electronic device 1201 and the external electronic device 1202. For example, if the external electronic device 1203 is a connected car as in FIG. 12B, the second electronic device 1201 may receive the location information received from a GPS sensor that is one of sensors of the external electronic device 1203 through communication between the external electronic device 1203 and the second electronic device 1201. The second electronic device 1201 may transmit the location information received from the external electronic device 1203 to the first electronic device as the connection information.

In another example embodiment, the second electronic device 1201 may receive the location information of the external electronic device 1203 by communicating with the external electronic device 1203 through beacon/BLE communication. The second electronic device 1203 may transmit to the first electronic device time required until arrival at an appointed place based on the received location information of the external electronic device 1203 and the appointed place included in the schedule information.

Further, in the event sharing region, states of the second electronic devices indicated by the user information may be displayed. For example, the states of the second electronic devices indicated by the user information may be displayed through reception of the connection information between the second electronic device and the external electronic device. As illustrated in FIG. 12A, if the external electronic device 1202 is an IoT device installed at home, the second electronic device 1201 may calculate a difference in distance between the external electronic device 1202 and the second electronic device 1201 through communication between the external electronic device 1202 and the second electronic device 1201. The communication may include beacon/BLE communication. The distance difference may be calculated by a logic implemented to calculate the distance between the external electronic device 1202 and the second electronic device. The external electronic device 1202 may be at least one of various IoT devices, and the logic implemented to calculate the distance may be different from a logic calculating the distance per IoT device or in accordance with the location of the IoT device installed at home.

The second electronic device 1201 may transmit the distance difference to the first electronic device as the connection information. As illustrated in FIG. 11C, the first electronic device may display the state of the second electronic device based on the distance difference received from the second electronic device. The state may be indicated as “departure” or “non-departure”.

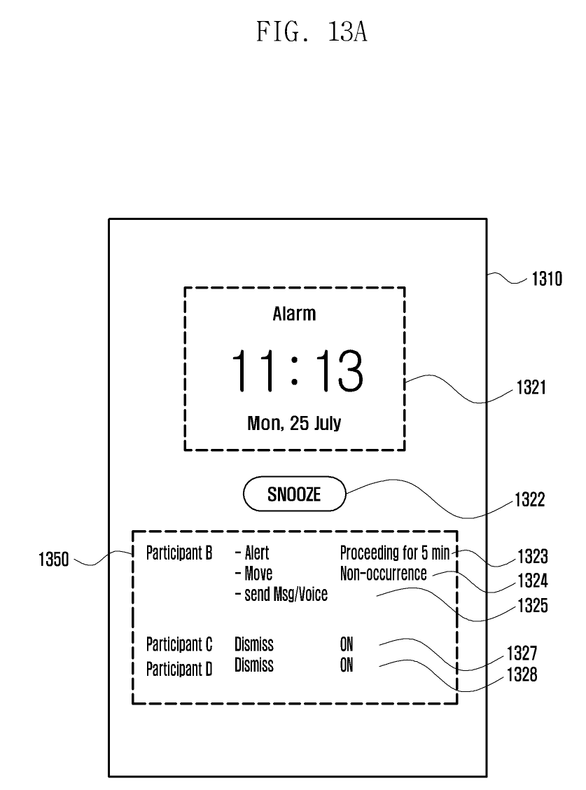

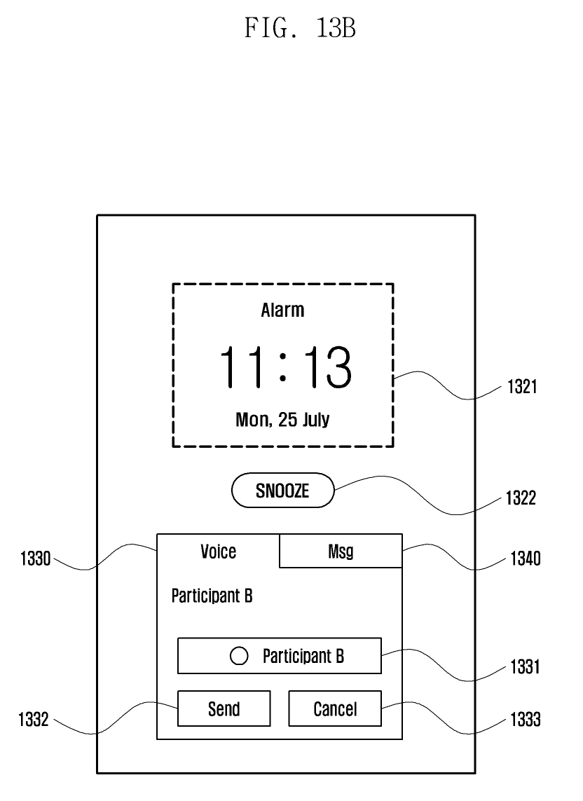

FIGS. 13A and 13B are diagrams illustrating a user interface according to various example embodiments of the present disclosure.

For easy explanation, it is assumed that FIG. 13A illustrates a user interface displayed on the first electronic device. Referring to FIG. 13A, the user interface 1310 may display a schedule information display region 1321, an alert control region 1322, and the user information related to the set group, and may include an event sharing region 1350 in which event information can be shared with the electronic devices meant by user information, for example, the second electronic devices.

In an example embodiment, in the event sharing region 1350, shared event information for the second electronic devices may be displayed.

For example, referring to FIG. 13A, in the event sharing region 1350, “Participant B”, “Participant C”, and “Participant D” may be displayed as user information indicating the second electronic device. Further, event information related to the user information may also be displayed.

As the event information related to “Participant B”, “Alert proceeding for 5 minutes” 1323 and “Move non-occurrence” 1324 may be displayed. “Alert proceeding for 5 minutes” 1323 may mean that alert generation related to the schedule has proceeded for 5 minutes. For example, it may be indicated that participant B does not release or suspend the alert in spite of the alarm generation. “Move non-occurrence” 1324 may mean that the electronic device of “participant B” does not move.

As the event information for “Participant C” and “Participant D”, “Dismiss On” 1327 and 1328 may be displayed. “Dismiss On” may indicate that two participants have performed suspension with respect to the alert related to the schedule.

In an example embodiment of the present disclosure, icons for sharing the event information between the second electronic devices may be displayed. An icon displayed in the event sharing region 1350 of FIG. 13A is an icon for sharing communication event information with “Participant B”, and may include “Send Msg/Voice” 1325. In response to the icon selection of the user of the first electronic device, a voice message or a text message may be transmitted to the second electronic device.

Referring to FIG. 13B illustrating a case where the user of the first electronic device selects the icon, the event sharing region may provide voice signal recording for transmitting a voice message, and may provide a text input for transmitting a text message.

In an example embodiment, if the user of the first electronic device selects “Voice” tap 1330 in order to transmit a voice message to participant B, the event sharing region may display a button 1331 for activating voice signal recording, a button 1332 for sending a recorded voice signal, and a cancellation button 1333. If selection of the button 1331 for activating recording of a user's voice signal is sensed, the first electronic device may activate a microphone of the first electronic device, and may store a voice signal received through the microphone in the memory. If user's selection of a “Send” button 1332 is sensed, the first electronic device may transmit the stored voice signal to the second electronic device indicated by participant B. The microphone of the first electronic device may include at least a part of the microphone 288 of FIG. 2. For example, the user of the first electronic device may send a voice message or a text message, such as “Wake up!” or “Get ready!”, to participant B who is the user of the second electronic device that does not move while the alert is generated for 5 minutes.

In various example embodiments of the present disclosure, a recording medium recorded with a program for executing a method for sharing a schedule including setting schedule information, generating a group to share the schedule information, requesting external electronic devices related to the generated group to approve group generation, displaying a user interface including the schedule information and user information of the external electronic devices that have approved the group generation, and displaying event information received from the external electronic devices on the user interface.

It will be understood that the above-described example embodiments are exemplary to help easy understanding of the contents of the present disclosure and do not limit the scope of the present disclosure. Accordingly, the scope of the present disclosure is defined by the appended claims, and it will be construed that all corrections and modifications derived from the meanings and scope of the following claims and the equivalent concept fall within the scope of the present disclosure.

What is claimed is:

1. An electronic device comprising:
a display including a touch screen;
a communication circuitry configured to communicate with a server, an external electronic device, and a second external electronic device;
a sensor;
a processor; and
a memory electrically connected to the processor,
wherein the memory stores instructions for causing the processor to be configured to:
set schedule information,
generate a group to share the schedule information,
control the communication circuitry to request external electronic devices related to the generated group to approve group generation,
control the display to display a user interface including the schedule information and user information of the external electronic devices that have approved the group generation,
control the communication circuitry to receive event information from the external electronic devices, and
control the display to display the received event information.

2. The electronic device of claim 1, wherein the processor is configured to display an alert if time of the schedule information arrives.

3. The electronic device of claim 1, wherein the processor is configured to control the communication circuitry to transmit event information related to a generated event to the external electronic devices if the event is generated by the electronic device.

4. The electronic device of claim 3, wherein the event information includes connection information regarding the second external electronic device, and
the connection information regarding the second external electronic device includes distance information calculated through communication with the second external electronic device and GPS information received from the second external device.

5. The electronic device of claim 4, wherein the second external electronic device comprises at least one of an internet of things (IoT) device and a connected car.

6. The electronic device of claim 3, wherein the event information includes operation information related to the schedule information, and
the operation information related to the schedule information includes information indicating one of release and suspension of an alert related to the schedule information.

7. The electronic device of claim 3, wherein the event information includes sensing information, and
the sensing information includes information received from sensors of the electronic device.

8. The electronic device of claim 3, wherein the event information includes communication event information, and
the communication event information includes a voice signal and text information received through the user interface.

9. The electronic device of claim 3, wherein the event information includes payment service information, and
the payment service information includes information related to payment details received through the electronic device.

10. The electronic device of claim 1, wherein the processor is configured to generate the group based on pre-stored user information of the external electronic devices.

11. The electronic device of claim 10, wherein the user information is identification information including name and account information.

12. The electronic device of claim 1, wherein the processor is configured to control the communication circuitry to request the server to perform the group generation, and
to receive from the server user information of the external electronic devices related to the group generated by the server.

13. The electronic device of claim 12, wherein the group generated by the server is a group set based on the user information of the external electronic devices preregistered in the server.

14. The electronic device of claim 1, wherein the processor is configured to transmit a message including the schedule information and the user information of the external electronic devices to the external electronic devices related to the generated group.

15. The electronic device of claim 1, wherein the processor is configured to display a user interface including the schedule information and user information related to the external electronic devices that have approved the group generation.

16. A method for sharing a schedule in an electronic device, comprising:
setting schedule information;
generating a group to share the schedule information;
requesting external electronic devices related to the generated group to approve group generation;
displaying a user interface including the schedule information and user information of the external electronic devices that have approved the group generation; and
displaying event information received from the external electronic devices on the user interface.

17. The method of claim 16, further comprising displaying an alert if time of the schedule information arrives.

18. The method of claim 16, further comprising transmitting event information related to a generated event to the external electronic devices if the event is generated by the electronic device.

19. The method of claim 18, wherein the event information includes connection information regarding a second external electronic device, and
the connection information regarding the second external electronic device includes distance information calculated through communication with the second external electronic device and GPS information regarding the second external device.

20. The method of claim 19, wherein the second external electronic device comprises at least one of an internet of things (IoT) device and a connected car.

21. The method of claim 18, wherein the event information includes operation information related to the schedule information, and
the operation information related to the schedule information includes information indicating at least one of release and suspension of an alert related to the schedule information.

22. The method of claim 18, wherein the event information includes sensing information, and
the sensing information includes information received from sensors of the electronic device.

23. The method of claim 18, wherein the event information includes communication event information, and
the communication event information includes a voice signal and text information received through the user interface.

24. The method of claim 18, wherein the event information includes payment service information, and
the payment service information includes information related to payment details received through the electronic device.

25. The method of claim 16, wherein generating the group comprises generating the group based on pre-stored user information of the external electronic devices.

26. The method of claim 25, wherein the user information is identification information including name and account information.

27. The method of claim 16, wherein generating the group comprises:
requesting a server connected to the electronic device to perform the group generation; and
receiving the user information of the external electronic devices related to the group generated by the server that have responded to the request.

28. The method of claim 27, wherein the group generated by the server is set based on user information of the external electronic devices preregistered in the server.

29. The method of claim 16, wherein requesting the group generation approval comprises transmitting a message including the schedule information and the user information of the external electronic devices to the external electronic devices related to the generated group.

30. The method of claim 16, wherein displaying the interface comprises displaying a user interface including the schedule information and user information related to the external electronic devices that have approved the group generation.

31. A non-transitory recording medium storing a program for executing the method of claim 16.
